(19) United States
(12) Patent Application Publication
(10) Pub. No.: US 2016/0006132 A1
(43) Pub. Date: Jan. 7, 2016

(54) DUAL-FEED DUAL-POLARIZATION HIGH DIRECTIVITY ARRAY ANTENNA SYSTEM

(71) Applicants: LITE-ON ELECTRONICS (GUANGZHOU) LIMITED, GUANGZHOU (CN); LITE-ON TECHNOLOGY CORPORATION, TAIPEI CITY (TW)

(72) Inventor: CHENG-TSE LEE, YILAN COUNTY (TW)

(21) Appl. No.: 14/470,919

(22) Filed: Aug. 27, 2014

(30) Foreign Application Priority Data
Jul. 4, 2014 (CN) 201420369372.7

(51) Int. Cl. H01Q 21/00; H01Q 21/30; H01Q 19/10

(52) U.S. Cl. CPC H01Q 21/0006; H01Q 19/10; H01Q 21/30

(57) ABSTRACT

An exemplary embodiment of the present disclosure provides a dual-feed dual-polarization high directivity array antenna system. The dual-feed dual-polarization high directivity array antenna system comprises a substrate, a first array radiating group, a second array radiating group, a third array radiating group, a first feed network, and a second feed network. The first feed network is electrically connected to the first and second array radiating groups for inputting a first signal to the first and second array radiating groups. The second feed network is electrically connected to the second and third array radiating groups for inputting a second signal to the second and third array radiating groups. The feed directions of the first and second feed networks are perpendicular to each other. Accordingly, the array antenna system can provide orthogonal feed signals. The array antenna system also has the advantages of high isolation, dual polarization and high gain.

### BACKGROUND

1. Technical Field

The present disclosure relates to an array antenna system, in particular, a dual-feed dual-polarization high directivity array antenna system is provided.

2. Description of Related Art

With the continuous advance of wireless communication technology, electronic products with wireless communication are being replaced with new ones all along. Wireless communication technology mainly uses the antenna to transmit and receive electromagnetic signals. Therefore, the design of the antenna seriously affects the communication quality and transmission speed of electronic products.

The antenna of existing access point mostly adopts an inverted F antenna, a monopole antenna or a dipole antenna. However, these antennas are not suitable for outdoor environments, and are only suitable for indoor environments.

The antenna needs to have the characteristics of high directivity, high gain and narrow beam width for the access point used in the outdoor environment. The access point with the antennas can excite the electromagnetic energy, which concentrates in a desired direction for achieving long distance transmission. The antenna most used to achieve aforementioned characteristic could be a patch antenna, a grid antenna or a disk antenna, wherein the grid antenna and the disk antenna have higher manufacturing costs.

In general, the electronic products of wireless communication are moving mostly toward lightweight design, and then the antenna has the application of multi-input multi-output (MIMO) for achieving growing demand for transmission capacity. In other words, the MIMO antenna system can enhance the data transmission rate.

Current access point of the outdoor environment mostly uses the MIMO antenna system with dual-feed design to highly improve the data transmission rate. However, it is very challengeable to design a dual-feed antenna system which has the characteristics of achieving good impedance matching, high isolation, and high gain in the limited space and without a significant increase in costs.

### SUMMARY

The present disclosure relates to a dual-feed dual-polarization high directivity array antenna system. The dual-feed dual-polarization high directivity array antenna system is a MIMO antenna system, wherein the antenna system in the invention has the characteristics of high gain, high isolation and dual-polarization for well signal transmission and reception.

An exemplary embodiment of the present disclosure provides a dual-feed dual-polarization high directivity array antenna system. The dual-feed dual-polarization high directivity array antenna system includes a substrate, a first array radiating group, a second array radiating group, a third array radiating group, a first feed network, a second feed network, and a reflective plate, wherein the substrate is a rectangle with a first long edge and a first short edge. The first array radiating group has N first radiating elements which are arranged parallel with the first long edge, wherein the N first radiating elements are disposed on the substrate and each the same size. The second array radiating group has N second radiating elements which are arranged parallel with the first long edge, wherein the N second radiating elements are disposed on the substrate and each the same size, and wherein N is a positive integer and greater than or equal to 2. The exemplary embodiment of the present disclosure provides a first interval between the first array radiating group and the second array radiating group. The third array radiating group has N third radiating elements which are arranged parallel with the first long edge, wherein the N third radiating elements are disposed on the substrate and each the same size. The N first radiating elements, the N second radiating elements and the N third radiating elements have the same shape. The exemplary embodiment of the present disclosure provides a second interval between the second array radiating group and the third array radiating group. The first feed network is disposed on the substrate and connected with the first array radiating group and the second array radiating group. The first feed network is configured for inputting a first signal to the first array radiating group and the second array radiating group. The second feed network is disposed on the substrate and connected with the second array radiating group and the third array radiating group. The second feed network is configured for inputting a second signal to the second array radiating group and the third array radiating group. The feed direction of the first feed network and the second feed network are perpendicular to each other. Furthermore, the first array radiating group, the second array radiating group, and the first feed network are configured for providing a first operating frequency band. The second array radiating group, the third array radiating group, and the second feed network are configured for providing a second operating frequency band. The reflective plate is disposed under the substrate and spaced apart from the substrate by a third interval.

To sum up, the dual-feed dual-polarization high directivity array antenna system can be divided into three groups of the array antenna. In addition, by adopting two sets of feed-in port design, the antenna system can provide orthogonal signals to the radiating elements, so avoiding mutual interferences of the signals. Accordingly, the dual-feed dual-polarization high directivity array antenna system of the present invention has the characteristic of high isolation, dual-polarization and high gain.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a perspective view showing the dual-feed dual-polarization high directivity array antenna system for the first embodiment of the instant disclosure.

FIG. 2 is a lateral view showing the dual-feed dual-polarization high directivity array antenna system for the first embodiment of the instant disclosure.

FIG. 3 is a top view showing the dual-feed dual-polarization high directivity array antenna system for the first embodiment of the instant disclosure.

FIG. 4 is a perspective view showing the dual-feed dual-polarization high directivity array antenna system for the second embodiment of the instant disclosure.

FIG. 5 are the XZ and YZ plane radiation patterns of the first operating frequency band showing the dual-feed dual-polarization high directivity array antenna system for the first embodiment of the instant disclosure.

FIG. 6 are the XZ and YZ plane radiation patterns of the second operating frequency band showing the dual-feed dual-polarization high directivity array antenna system for the first embodiment of the instant disclosure.

FIG. 7 is a S11, S22, S21 curve diagram showing the dual-feed dual-polarization high directivity array antenna system for the first embodiment of the instant disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

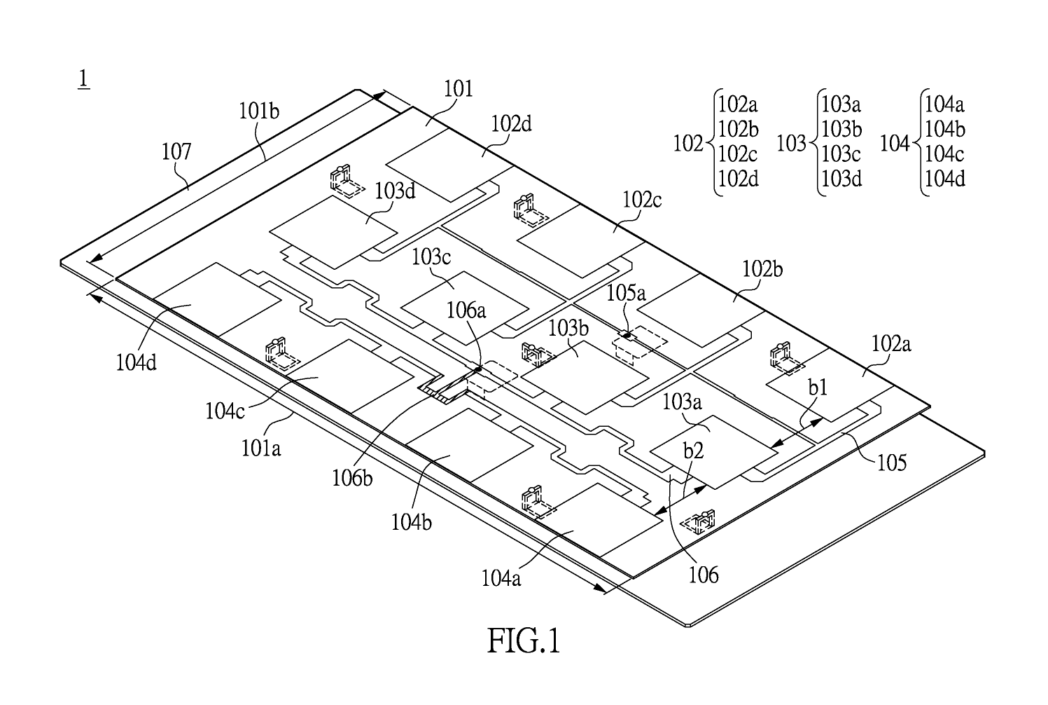

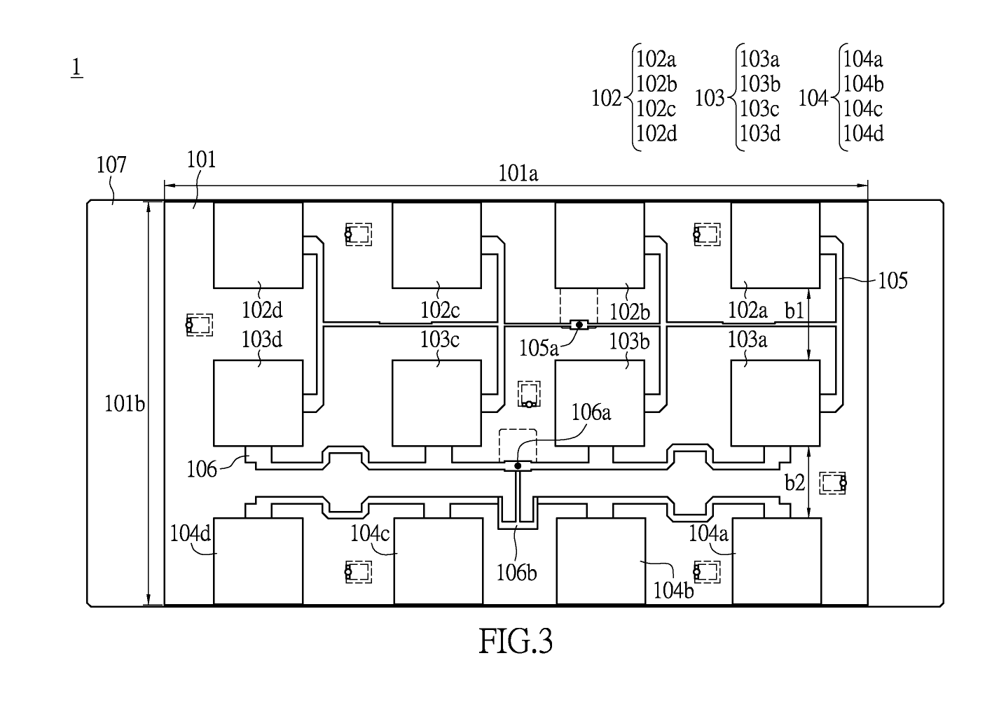

Referring to FIG. 1-3, the dual-feed dual-polarization high directivity array antenna system 1 of the instant disclosure includes a substrate 101, a first array radiating group 102, a second array radiating group 103, a third array radiating group 104, a first feed network 105, and a second feed network 106.

The substrate 101 is a rectangle with a first long edge 101a and a first short edge 101b. In this embodiment, the substrate 101 may, for example, be a printed circuit board (PCB). In another embodiments, the substrate 101 may also be an epoxy glass cloth laminated board (FR4) or a polyimide substrate. However, the present disclosure is not limited thereto.

The first array radiating group 102 is formed by N first radiating elements 102a-102d which have the same size. The N first radiating elements 102a-102d are disposed on the substrate 101 and arranged parallel with the first long edge 101a, so as to form a 1×N array. In the instant embodiment, the N first radiating elements 102a-102d are arranged adjacent to each other on the substrate 101 and equidistantly spaced.

The second array radiating group 103 is formed by N second radiating elements 103a-103d which have the same size. The N second radiating elements 103a-103d are disposed on the substrate 101 and arranged parallel with the first long edge 101a, so as to form a 1×N array. It is worth noting that there is a first interval b1 between the second array radiating group 103 and the first array radiating group 102. In the instant embodiment, the N second radiating elements 103a-103d are arranged adjacent to each other on the substrate 101 and equidistantly spaced.

The third array radiating group 104 is formed by N third radiating elements 104a-104d which have the same size. The N third radiating elements 104a-104d are disposed on the substrate 101 and arranged parallel with the first long edge 101a, so as to form a 1×N array. It is worth noting that there is a second interval b2 between the third array radiating group 104 and the second array radiating group 103. In the instant embodiment, the N third radiating elements 104a-104d are arranged adjacent to each other on the substrate 101 and equidistantly spaced. The N first radiating elements, the N second radiating elements and the N third radiating elements have the same shape.

In this instant embodiment, the first, second and third array radiating groups 102, 103, 104 have the same number of the radiation elements, wherein N is equal to 4. It is worth noting that the present disclosure does not limit the number of the radiation elements. The number of the radiation elements can be substantially greater than or equal to 2 according to product specifications or actual requirements.

The first feed network 105 is disposed on the substrate 101 and electrically connected with the first array radiating group 102 and the second array radiating group 103, and the first feed network 105 is configured for inputting a first signal to the first array radiating group 102 and the second array radiating group 103.

The second feed network 106 is disposed on the substrate 101 and electrically connected with the second array radiating group 103 and the third array radiating group 104. The second feed network 106 is configured for inputting a second signal to the second array radiating group 103 and the third array radiating group 104. According to the above description, it is worth noting that the first feed network 105 and the second feed network 106 are respectively inputting the first signal and the second signal in common to the second radiating elements 103a-103d.

The feed directions of the first feed network 105 and the second feed network 106 are perpendicular to each other. Therefore, when the first radiating elements 102a-102d and the second radiating elements 103a-103d receive the first signal, the radiating elements will stimulate an electromagnetic wave of a first polarization direction. When the second radiating elements 103a-103d and the third radiating elements 104a-104d receive the second signal, the radiating elements will stimulate an electromagnetic wave of a second polarization direction. The first polarization direction and the second polarization direction are orthogonal to each other. Accordingly, the second radiating elements 103a-103d can simultaneously receive the first signal and the second signal, and stimulate electromagnetic waves that are less likely to affect each other.

The first array radiating group 102, the second array radiating group 103, and the first feed network 105 are configured for providing a first operating frequency band. The second array radiating group 103, the third array radiating group 104, and the second feed network 106 are configured for providing a second operating frequency band. The feed directions of the first feed network 105 and the second feed network 106 are perpendicular to each other. Therefore, the electromagnetic waves of the first operating frequency band and the second operating frequency band have the orthogonal polarization direction, and its center frequency can be similar. The dual-feed dual-polarization high directivity array antenna system 1 has the characteristics of broadband operation.

In this instant embodiment, the first feed network 105 is positioned between the first array radiating group 102 and the second array radiating group 103, and the second feed network 106 is positioned between the second array radiating group 103 and the third array radiating group 104. However, the present disclosure is not limited thereto. Moreover, the present disclosure does not limit the shape of the radiating elements. On the other hand, the shape of the first radiating elements 102a-102d, the second radiating elements 103a-103d and the third radiating elements 104a-104d can be one of square, circle, rectangle and oval.

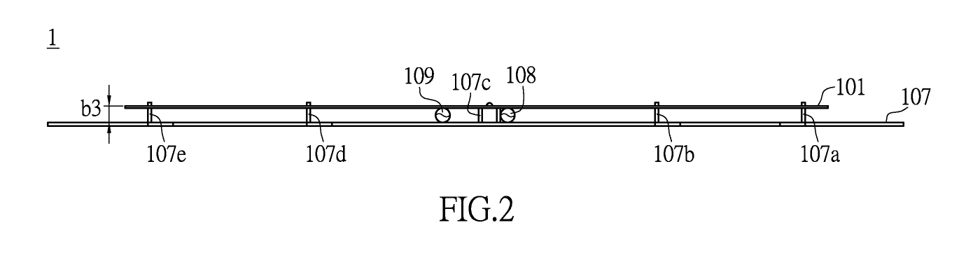

Referring to FIG. 1 and FIG. 2, the reflective plate 107 is disposed under the substrate 101 and parallel with the substrate 101. The reflective plate 107 is spaced apart from the substrate 101 by a third interval b3. The reflective plate 107 is provided with a plurality of fixed portions 107a-107e at the top, wherein the fixed portions 107a-107e are configured for fixing the reflective plate 107 to the substrate 101, such that the electromagnetic energy generated by the dual-feed dual-polarization high directivity array antenna system 1 can be focused to a specific direction. Further, the dual-feed dual-polarization high directivity array antenna system 1 not only generates the characteristics of high directivity and high gain, but also effectively increases the signal transmission distance. Moreover, the present disclosure does not limit the structure of the reflective plate 107. For example, the structure of the reflective plate 107 may be a metal-plate of tinplate, stainless steel or aluminum.

The dual-feed dual-polarization high directivity array antenna system 1 further comprises a first feed-in port 105a, a second feed-in port 106a, a first input source 108 and a second input source 109. Wherein the first feed-in port 105a is disposed on the first feed network 105, and the second feed-in port 106a is disposed on the second feed network 106. Wherein one end of the first input source 108 is electrically connected to the first feed-in port 105a, and other end thereof is electrically connected to the reflective plate 107. One end of the second input source 109 is electrically connected to the second feed-in port 106a, and other end thereof is electrically connected to the reflective plate 107. Furthermore, the dual-feed dual-polarization high directivity array antenna system 1 further comprises a phase adjustment portion 106b. The phase adjustment portion 106b is disposed on the second feed network 106, wherein one end of the phase adjustment portion 106b is electrically connected to the second feed-in port 106a, and other end thereof is electrically connected to the third radiating elements 104a-104d of the third array radiating group 104. The phase adjustment portion 106b is configured for adjusting the phase of the second signal, wherein the phase difference between the second signal and the third array radiating group after adjusting the second signal is equal to 180 degrees, and the first signal provided by the first input source and the second signal provided by the second input source have the same phase.

Moreover, the radiating elements 102a-102d, 103a-103d, 104a-104d of each of the array radiating groups 102, 103, 104 are not necessarily the same size. For example, the size of the first radiating elements 102a-102d do not necessarily equal to the size of the second radiating elements 103a-103d or the third radiating elements 104a-104d. When the dual-feed dual-polarization high directivity array antenna system 1 is excited, the main purpose of the above design is that it can produce a plurality of adjacent antenna resonant modes by adjusting the size of the radiating elements. Thus, it can be combined into a wider operating bandwidth.

In more detail, the length and width of the transmission line of the first feed network and the second feed network can be adjusted to achieve the purpose of in-phase metal surface current on the substrate 101. Then the radiating elements can generate the constructive interference in space through radiation energy which is generated by each of the radiating elements. This can achieve the purpose of concentrated radiation energy by the high directional antenna radiation pattern.

Furthermore, in this instant embodiment, the first operating frequency band and the second operating frequency band cover a 5 GHz operating frequency range. The lengths of the first interval b1 and the second interval b2 are about in between 0.2 times to 0.5 times the wavelength corresponding to the center frequency of the operating frequency band, and the spacing of the each radiating elements 102a-102d, 103a-103d, 104a-104d are also about in between 0.2 times to 0.5 times the wavelength corresponding to the center frequency of the operating frequency band. The circumference of each radiating elements 102a-102d, 103a-103d, 104a-104d is about 2 times of the wavelength corresponding to the center frequency of the operating frequency band. The length of the third interval b3 is smaller than one-sixth of the wavelength corresponding to the lower frequency of the first operating frequency band and the second operating frequency band

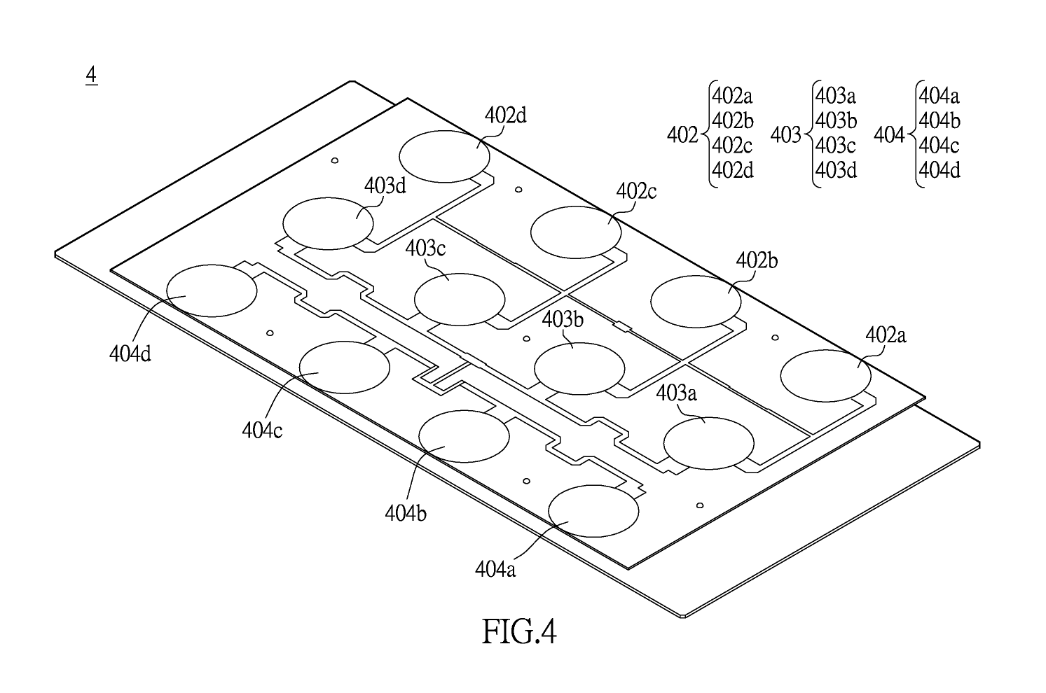

Referring to FIG. 4, FIG. 4 is a perspective view showing the dual-feed dual-polarization high directivity array antenna system for the second embodiment of the instant disclosure. The differences between the second embodiment and the first embodiment is that the shapes of the first, second and third radiating elements 402a-402d, 403a-403d, 404a-404d shown by FIG. 4 are not squares. In this case the shapes of the first, second and third radiating elements 402a-402d, 403a-403d, 404a-404d are circles. In brief, the present disclosure is not limited thereto.

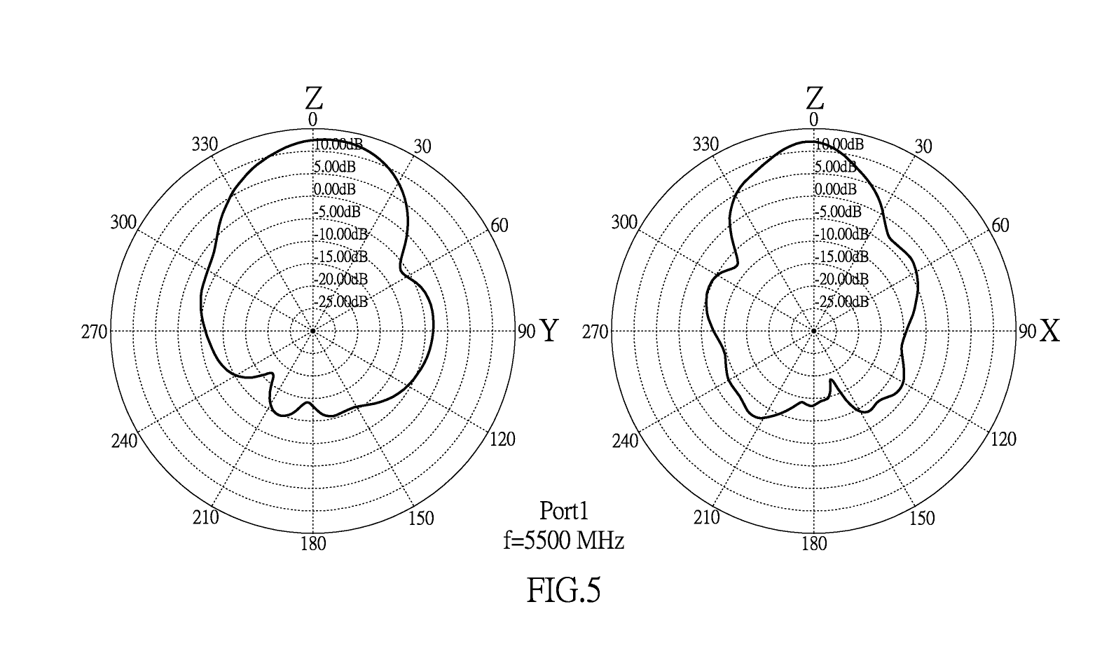

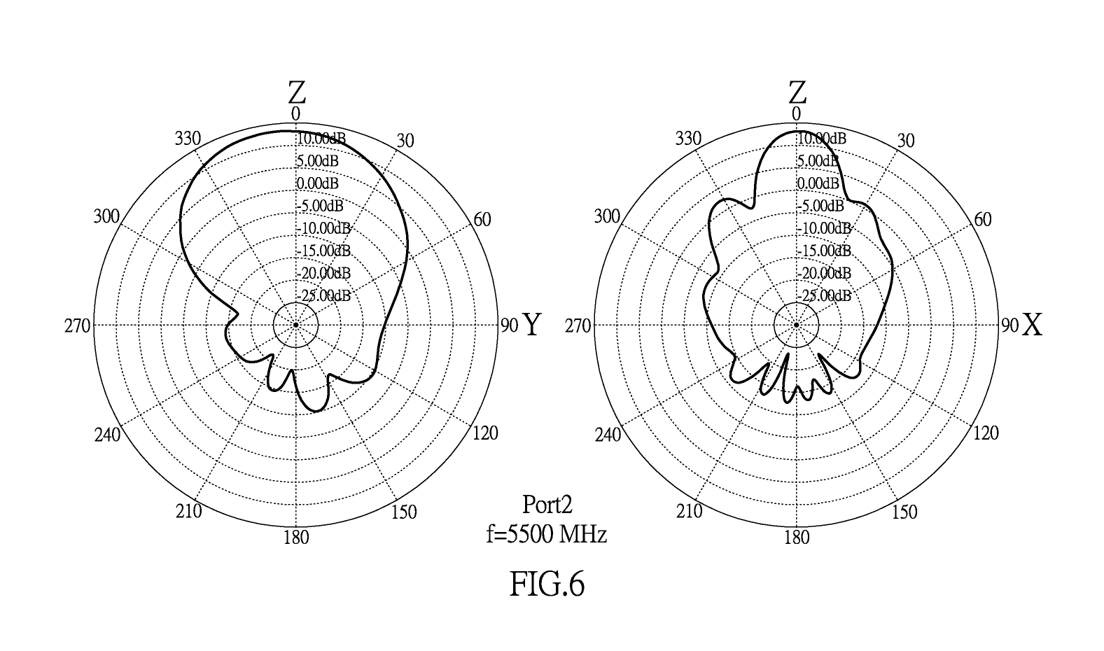

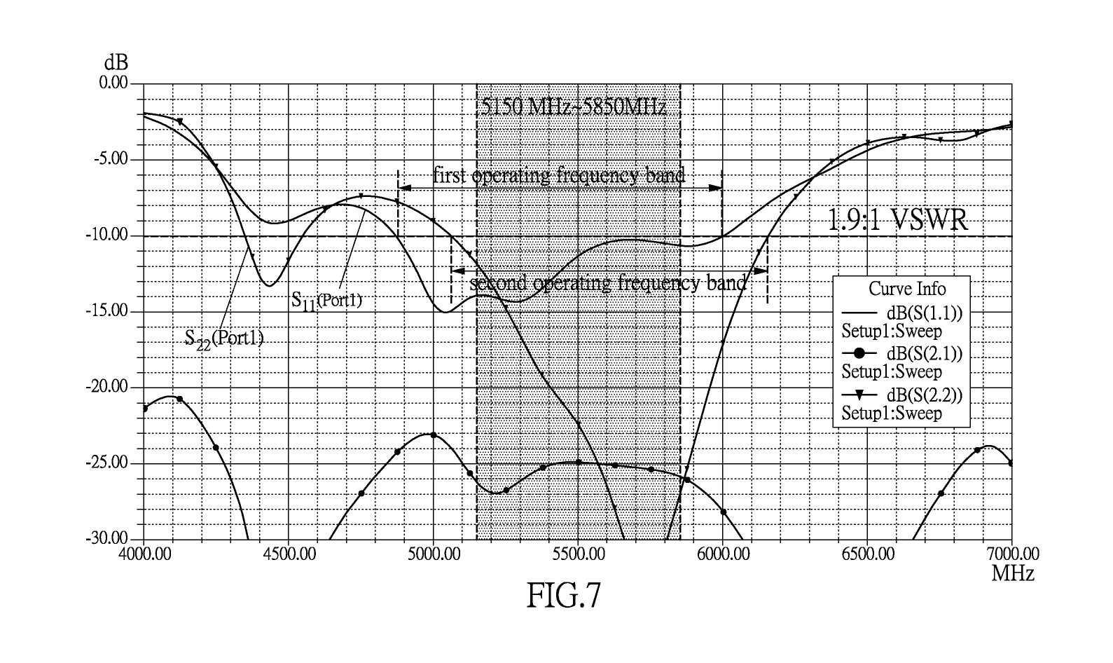

Referring to FIG. 5-7, FIG. 5 are the XZ and YZ plane radiation patterns of the first operating frequency band showing the dual-feed dual-polarization high directivity array antenna system for the first embodiment of the instant disclosure, wherein the center frequency is equal to 5500 MHz. FIG. 6 are the XZ and YZ plane radiation patterns of the second operating frequency band showing the dual-feed dual-polarization high directivity array antenna system for the first embodiment of the instant disclosure, wherein the center frequency is equal to 5500 MHz. FIG. 7 is an S₁₁, S₂₂, S₂₁ curve diagram showing the dual-feed dual-polarization high directivity array antenna system for the first embodiment of the instant disclosure. Based upon FIG. 5-6 it can be seen that the dual-feed dual-polarization high directivity array antenna system of the present invention has a characteristic of high directivity. Next, based upon FIG. 7 it can be seen that the reflection coefficient (S₁₁, S₂₂) of the first operating frequency band and the second operating frequency band is less than −10 dB. Further, the degree of isolation (S₂₁) of the first operating frequency band and the second operating frequency band is very low (i.e. the dual-feed dual-polarization high directivity array antenna system has a characteristic of high isolation).

To sum up, a dual-feed dual-polarization high directivity array antenna system provided by the present disclosure can be divided into three groups of the array antenna and adopt two sets of feed-in port design, such that the array antennas can be excited to generate electromagnetic waves of different polarization directions, thereby avoiding interference in between the the signals excited by two ports. Accordingly, the dual-feed dual-polarization high directivity array antenna system of the present invention has the characteristics of high isolation, dual-polarization and high gain.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A dual-feed dual-polarization high directivity array antenna system, comprising:
a substrate with a first long edge and a first short edge;
a first array radiating group, having N first radiating elements which are disposed on the substrate and arranged parallel with the first long edge, wherein the N first radiating elements have the same size;
a second array radiating group, having N second radiating elements which are disposed on the substrate and arranged parallel with the first long edge, wherein the N second radiating elements have the same size, and a first interval is between the second array radiating group and the first array radiating group;
a third array radiating group, having N third radiating elements which are disposed on the substrate and arranged parallel with the first long edge, wherein the N third radiating elements have the same size, wherein the N third radiating elements, the N first radiating elements and the N second radiating elements have the same shape, and a second interval is between the third array radiating group and the second array radiating group;
a first feed network, disposed on the substrate and electrically connected to the first array radiating group and the second array radiating group, configured for inputting a first signal to the first array radiating group and the second array radiating group;
a second feed network, disposed on the substrate and electrically connected to the second array radiating group and the third array radiating group, configured for inputting a second signal to the second array radiating group and the third array radiating group; and
a reflective plate, disposed under the substrate and spaced apart from the substrate by a third interval;
wherein the feed directions of the first feed network and the second feed network are perpendicular to each other, the first array radiating group, the second array radiating group, and the first feed network are configured for providing a first operating frequency band, the second array radiating group, the third array radiating group, and the second feed network are configured for providing a second operating frequency band, wherein N is a positive integer and greater than or equal to 2.

2. The dual-feed dual-polarization high directivity array antenna system according to claim 1, wherein the reflective plate is provided with a plurality of fixed portions at the top, and the fixed portions are configured for fixing the reflective plate to the substrate.

3. The dual-feed dual-polarization high directivity array antenna system according to claim 1, further comprising:
a first feed-in port, disposed on the first feed network;
a second feed-in port, disposed on the second feed network;
a first input source, one end thereof electrically connected to the first feed-in port, the other end thereof electrically connected to the reflective plate; and
a second input source, one end thereof electrically connected to the second feed-in port, the other end thereof electrically connected to the reflective plate.

4. The dual-feed dual-polarization high directivity array antenna system according to claim 3, further comprising a phase adjustment portion disposed on the second feed network, wherein the phase adjustment portion is electrically connected to the third array radiating group, and the phase adjustment portion is configured for adjusting the phase of the second signal and transmitting after adjusting the second signal to the third array radiating group, wherein the phase difference between the second signal and the third array radiating group after adjusting the second signal is equal to 180 degrees, and the first signal provided by the first input source and the second signal provided by the second input source have the same phase.

5. The dual-feed dual-polarization high directivity array antenna system according to claim 1, wherein N is equal to 4.

6. The dual-feed dual-polarization high directivity array antenna system according to claim 1, wherein the first feed network is positioned between the first array radiating group and the second array radiating group, and the second feed network is positioned between the second array radiating group and the third array radiating group.

7. The dual-feed dual-polarization high directivity array antenna system according to claim 1, wherein the shape of the N first radiating elements, N second radiating elements and N third radiating elements is one of square, circle, rectangle and oval.

8. The dual-feed dual-polarization high directivity array antenna system according to claim 1, wherein the length of the first interval interposed is between 0.2 times to 0.5 times the wavelength corresponding to the center frequency of the first operating frequency band, the length of the second interval interposed is between 0.2 times to 0.5 times the wavelength corresponding to the center frequency of the second operating frequency band.

9. The dual-feed dual-polarization high directivity array antenna system according to claim 1, wherein the first operating frequency band and the second operating frequency band cover a 5 GHz operating frequency range.

10. The dual-feed dual-polarization high directivity array antenna system according to claim 1, wherein the length of the third interval is smaller than one-sixth of the wavelength corresponding to the lower frequency of the first operating frequency band and the second operating frequency band.
